(19) United States
(12) Patent Application Publication
(10) Pub. No.: US 2006/0238403 A1
(43) Pub. Date: Oct. 26, 2006

(54) Method and system for destroying rockets

(75) Inventors: Oded M Golan, Kfar Vradim (IL); Haim Weiss, Haifa (IL); Israel Lupa, Kiryat Ono (IL); Ran Fishman, Rehovot (IL)

Correspondence Address: BROWDY AND NEIMARK, P.L.L.C.;624 NINTH STREET, NW, SUITE 300, WASHINGTON, DC, 20001-5303, US

(73) Assignee: Rafael Armament Development Authority Ltd.

(21) Appl. No.: 10/563,296

(22) PCT Filed: Jul. 1, 2004
(86) PCT No.: PCT/IL04/00590

§ 371 Date: Jun. 14, 2006

(30) Foreign Application Priority Data
Jul. 2, 2003 (IL) 156739

(51) Int. Cl. G01S 13/72

(52) U.S. Cl. 342/62; 342/59; 342/95; 342/96; 342/97; 342/107; 342/126; 342/67

(57) ABSTRACT

A system that includes a synchronized network of three search and track radars and associated processing means and communication channels. The radars are configured to detect and track the target. In response to detected target, an interceptor is launched towards the target. The radars are configured to measure and track the target and the interceptor. The target and interceptor ranges are accurately measured by the radars in the synchronized network, giving rise to synchronized accurate range measurements that are combined by range triangulation to provide accurate target and interceptor position measurements irrespective of the angular measurement accuracy of each radar. The processing means are configured to utilize the measurements to calculate interceptor maneuvers required to overcome errors and bring the interceptor close to a target. The maneuver commands are transmitted to the interceptor using the communication channel. The interceptor is equipped with kill mechanism designed to destroy a target warhead when the interceptor approaches the target.

### FIELD OF THE INVENTION

The present invention is in the general field of Air Defense Systems for the Interception of Ground-to-Ground Rockets. The components of the present invention could be used also separately in applications of detection and/or tracking of objects and in interceptors design.

### BACKGROUND OF THE INVENTION

[1] Fadjr-5 333 mm rocket, Jane's Ammunition Handbook, August 2002.
[2] RFAS 122 mm BM-21 Grad series rockets, Jane's Ammunition Handbook, August 2002.
[3] Merrill I. Skolnik, Introduction to Radar Systems, McGraw Hill 2000.
[4] David K. Barton, Radar Technology Encyclopedia, Artech House Inc. 1997.
[5] RIM-116 RAM (Mk 31 Guided Missile Weapon System)/SEA RAM/RAPIDS, Jane's Naval Weapon Systems, 2002.
[6] U.S. Pat. No. 6,209,820.

Artillery rockets impose a difficult challenge for any air defense system, being relatively low signature, fast moving targets. Typically, this weapon is launched in salvos, requiring the defending side to engage multiple targets simultaneously. At present there is no operational system dedicated for this kind of threat. There are several systems developed particularly to defend against medium and long range ballistic missiles, such as the Arrow, Thaad, and PAC-3 programs. These programs use large phased array radars that are capable of detecting multiple targets at long ranges, and sophisticated missiles equipped with on-board seekers that are used during the end-game phase of the interception.

For the short range ballistic targets the only program that was explicitly facing this threat is the THEL—the Mobile Tactical High Energy Laser that is in development stages and has proved capability in tests against Katyusha rockets. The Mobile Tactical High Energy Laser uses a high-energy, deuterium fluoride chemical laser that is directed to its target by radar. The main drawbacks of the THEL solution are the dependence on high visibility and its high cost.

While no operational weapon system that is specifically developed to deal with the artillery rocket threat currently exists, many air defense systems claim capability against tactical missiles or air-to-surface precision weapons. Many of them are used in the naval arena to protect navy ships against missile attacks. The RAM missile is one example for such a weapon. The BARAK ship point defense missile is another. The RAM missile is equipped with a seeker that is used to guide the missile to a short distance from its target. The BARAK missile has no seeker, and is guided to its target by special fire control radar mounted on the ship. A use of remote sensing for target interception limits the weapon effective range, and makes it useful particularly for point defense purposes.

The need to protect high valued assets against multiple threats led to the introduction of air-defense guns with maneuvering shells that can correct errors in flight to increase accuracy, even against maneuvering targets. An example is the DART projectile that is guided by a high precision radar and is capable intercepting sea skimmers. Guns of this type are controlled by radar and have typical high fire rate. While the conventional air defense artillery was a statistical weapon, in the sense that many shell filled the air in order to increase the probability of hitting the target, the new trend is to increase precision by adding maneuvering capability to the projectile.

JANE'S DEFENCE UPGRADES—Nov. 1, 2002, New ammunition improves gun performance E R Hooton*

Abstract:

Two of OTO Melara's naval gun mountings—the 76 mm (3 in) Model 62 and 127 mm (5 in) Model 50—are to receive substantially enhanced performance under programmes to be completed by 2008.

A 127 mm Lightweight gun mounting has been produced to meet modern requirements, and recently completed qualification trials with the Italian frigate Bersagliere (see JDU Vol V No. 8 p 8).

The latest 76 mm gun is the Super Rapid variant, with a firing rate increased to 120 rds/min. It equips a variety of frigates including the French and Italian Horizon class, Norway's Nansen class and the new Saudi Arabian Arriyad class. Its high rate of fire reflects its role largely as an Anti-Air Warfare (AAW) system, especially against anti-ship missiles. OTO Melara has now received an Italian Navy contract to further enhance this capability through the Davide guided projectile programme. This is studying the feasibility of a beam-riding, high-velocity, guided projectile for use against manoeuvring targets.

This subcalibre projectile or DART (Driven Ammunition Reduced Time-offlight) has a discarding sabot. The front of the 3.4 kg DART consists of a programmable microwave proximity fuze (for greater discrimination against ‘clutter’ and false returns) and a canard-wing control unit. At the rear of the round are six fins and an RF (radio frequency) guidance receiver unit.

The round is fired in the same way as conventional ammunition and, once the DART has discarded its sabot, it is gathered into an RF illuminator beam directed at the target. The fuze has a radial sensitivity of >10 m, enabling the warhead to be detonated at the optimum distance and location to ensure that the maximum number of fragments strike the target, even at altitudes as low as 2 m and at ranges of >2.5 nm (5 km). The round flies at 1,200 m/s (Mach 3.5) and can maneuver at up to 50 g.

An unguided version of the DART might also be used for precision shore bombardment. While the range of the Super Rapid gun with SAPOMER (Semi-Armour-Piercing OTO Munition, Extended Range) is only 10.75 nm, OTO Melara claims that the DART could reach distances of 21.5 nm. Guided trials began this year and production is scheduled to begin in 2006.

The Rolling Airframe Missile (RAM) is the product of a US-German co-operation programme dating back to 1979, when the development memorandum of understanding (MoU) was signed. A production MoU was signed in August 1987, with the programme managed by a joint RAM Program Office staffed from the US Naval Sea Systems Command, the German Navy and the Federal Office of Defense Technology and Procurement (BWB). Prime contractors and co-operating partners are Raytheon Missile Systems in the USA and the German RAM-System GmbH consortium.

Operational since 1992, over 50 US and German ships are now armed with the missile, designed as an autonomous, quick-reaction, all-weather, fire-and-forget system using passive radio frequency/infrared (RF/IR) dual-mode guidance. The complete RAM Mk 31 Guided Missile Weapon System combines the Mk 44 Guided Missile Round Pack and the 21-cell Mk 49 Guided Missile Launching System (GMLS). The missile itself is designated RIM-116A (Block 0) and RIM-116B, (Block 1).

In its initial configuration (Block 0), RAM was designed to engage RF-radiating ASCMs, which represented the majority of the threat. The RF emission provided by the target's radar seeker is used by the dual-mode seeker of RAM for lock-on after launch and provides midcourse guidance; the IR radiation of the target is used for terminal guidance. Immediately after launch, the RF seeker guides the missile towards the target and points the IR seeker to the target direction, initiating RF midcourse guidance.

However, the IR seeker is a narrow-field device, capable of terminal target acquisition only. This requires the target to radiate in order to achieve passive RF acquisition for initial guidance.

In the latest Block 1 missile, the IR homing element of the missile has been upgraded with a completely new image-scanning seeker with intelligent digital signal processing. This confers IR-all-the-way guidance capability to the dual-mode system, enabling the engagement of non-RF-radiating targets in full range of the missile.

Target search and IR lock-on is autonomously performed by the seeker during flight. The digital signal processing, in combination with the instantaneous detector resolution, provides an excellent IR counter measures capability.

The Block 1 development programme was successfully completed in August 1999, with an Operational Evaluation (OPEVAL) conducted aboard the Self-Defense Test Ship to demonstrate the system's introduction maturity. In 10 scenarios, Harpoon, Exocet and supersonic (Mach 2.5) Vandal target missiles were intercepted and destroyed under realistic conditions. RAM Block 1 achieved first-shot kills on every target in its presented scenarios, including sea-skimming, diving and highly maneuvering profiles in both single and stream attacks. Milestone III approval for Block 1 full-rate missile production followed in January 2000.

A software upgrade to be introduced this year will enable Block 1 missiles to also engage fixed- and rotary-wing aircraft and surface targets. The Helicopter, Aircraft and Surface (HAS) capability will exploit the Block 1 missile's IR seeker design and performance characteristics, adding new software functionality to enable slow-flying air targets and surface vessels, such as fast attack craft (FACs), to be engaged. No hardware changes are required to accommodate the HAS modification.

The first export order for RAM was received in December 1999 when the Republic of Korea placed a US$24.9 million contract for three Mk 49 GMLSs (followed in October 2000 by a contract for 64 RAM Block 1 missiles) for its new KDX-2 air-defense destroyers. This was followed in April 2000 when Greece's Elefsis Shipyards signed a direct commercial sale with RAM-System for the supply of three Mk 49 GMLSs for three new 62 m FACs being built for the Hellenic Navy.

Oto Melara Refines DART

Defying the convention for smaller-caliber inner-layer gun systems, the Italian Navy remains wedded to the Oto Melara 76/62 Super Rapid medium-caliber gun as its last line of defense. The Super Rapid mounting was evolved with an air-defense bias but retaining a secondary anti-surface function. Capable of firing 120 rds/min, it has demonstrated a standard deviation of less than 0.3 mrad at 1,000 m per 10-round burst at maximum firing rate.

While a planned Course-Corrected Shell never reached production, the Italian Navy is currently sponsoring development of a new DART (Driven Ammunition Reduced Time) round by Oto Melara. Designed to be fully compatible with existing Compact and Super Rapid guns, DART is a subcaliber round (achieving a greater muzzle speed to realize longer range and/or a reduced flight time). It has a programmable RF proximity fuze-seeker intended to optimize lethality, and a continuous course-correction capability based on beam-riding guidance.

The round itself will have canard control surfaces mounted forward. Speed will be in excess of Mach 3, facilitating a very short time to intercept. Maximum range will be in the order of 5 km and, according to Oto Melara, there is no limitation on the number of projectiles in flight. The company adds that reaction time should be less than a missile system, and also claims that cost-per-kill and through-life costs will be somewhat less than an inner-layer missile system.

### SUMMARY OF THE INVENTION

The system in accordance with the invention provides regional and point defense against short range ballistic missile attack. The targets may consist of short range tactical ballistic missiles (e.g., Fadjr-5 333 mm rocket [1]) or a barrage of artillery rockets (e.g., RFAS 122 mm BM-21 [2]). The system provides defense against other airborne targets including aircraft, helicopters, UAVs, guided missiles etc.

By one embodiment, the system uses a synchronized network of low cost search and track radars that detect and track targets and provide sufficient data to generate an up-to-date theater air picture. The data is used to allocate the system resources and the interceptors to the targets and plan the engagement. The radars track new and engaged targets and measure the interceptors as well.

Using range triangulation with the range measurements of the synchronized radars, accurate positions of the targets and the interceptors are obtained, enabling interception based on remote sensing. This, in turn, reduces the cost of the interceptors that receive their guidance commands from the ground and need no on-board seeker to reach their target. The position measurements are used to calculate corrective maneuvers required to overcome errors and bring the interceptor close to the target. The maneuver commands are transmitted to the interceptors using uplink communication channel. The interceptors are equipped with kill mechanisms designed to destroy the targets warheads in order to minimize damage on the ground.

By one embodiment, two types of interceptors are integrated in the air defense system: a maneuvering projectile that is fired from an air defense gun, and a surface-to-air missile.

By this embodiment, the projectiles are used for point defense, providing low-cost protection of high value assets against a barrage of artillery rockets. The surface-to-air missiles have longer effective interception range and are used to protect larger areas against a salvo of short range ballistic missiles.

By one embodiment, the system performs the following tasks:
Search and detect potential ballistic targets (ground-to-ground artillery rockets and short range tactical ballistic missiles);
Tracking of multiple targets;
Target interception in saturated attack;
Target warhead destruction;
Kill assessment.

In addition, by this embodiment, the system should offer other air defense capabilities such as:
Detect, track and intercept other aerial threats (aircraft, helicopters, UAVs, gliders, etc.);
Determine launching site locations (in order to provide data to other forces to destroy rocket launchers).

System cost should be low with a special emphasis on low interceptor cost.

Accordingly, the system provides for a synchronized network of at least three search and track radars and associated processing means and communication channel; the radars are configured to detect and track at least one target; in response to detected at least one target, at least one interceptor is launched towards said at least one target; the radars are configured to measure and track the at least one target and the at least one interceptor; the target and interceptor ranges are accurately measured by said at least three radars in the synchronized network, giving rise to synchronized accurate range measurements; the synchronized measurements are combined by range triangulation to provide accurate target and interceptor position measurements irrespective of the angular measurement accuracy of each radar; the processing means are configured to utilize the measurements to calculate interceptor maneuvers required to overcome errors and bring the interceptor close to a target; the maneuver commands are transmitted to the interceptor using the communication channel; the interceptor is equipped with kill mechanism designed to destroy a target warhead when said interceptor approaches the target.

The invention further provides for a rolling interceptor being devoid of inertial roll sensor and equipped with circumferential communication antennae that are configured to receive maneuvering commands from a command transmitter; the interceptor is configured to use said antennae to provide a reference for resolution of the maneuvering commands.

By one embodiment, the synchronized network of low cost search and track radars that detect and track targets by range triangulation described herein can be used as a stand alone system for applications that require good tracking accuracy such as to genenerate an accurate air and/or naval and/or ground target picture and other applications that requiring accurate tracking of objects in a known location or process.

By one embodiment, the rolling interceptor being devoid of inertial roll sensor and equipped with circumferential communication antennae described herein could be also guided by other radar methods.

Similarly, by one embodiment, the trajectory shaping proposed in order to increase kill probability by creating final endgame geometry that is suitable for the particular kill mechanism in the interceptor, can be used in other interception systems that rely on other sensors.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates schematically a basic system configuration, in accordance with an embodiment of the invention;

FIG. 2 illustrates schematically radars, guns, missiles and BMC netting, in accordance with an embodiment of the invention;

FIG. 3 illustrates a flow chart of an engagement cycle in accordance with an embodiment of the invention;

FIG. 4 illustrates a block diagram of a guidance loop, in accordance with an embodiment of the invention;

FIG. 5 illustrates schematically a radar network, in accordance with an embodiment of the invention;

FIG. 6 illustrates a projectile layout, in accordance with an embodiment of the invention;

FIG. 7A illustrates a projectile communication section, in accordance with an embodiment of the invention; and

FIG. 7B illustrates roll measurement algorithm, in accordance with an embodiment of the invention.

### DETAILED DESCRIPTION OF SPECIFIC EMBODIMENTS

By one embodiment, the search and the detection of the targets are performed by a network of synchronized low cost radars (at least three radars). The positions of the targets and the interceptors are determined via range triangulation using an approach similar to GPS. The radars measure the range to an object (the target or the interceptor). The measurements are synchronized to a common time base using precise atomic clocks. Using this time base and the known location of the radars, the position of the object can be determined precisely from the range measurements. The accuracy of the calculated position depends on the radar characteristics and on the system geometry (the radars and the target relative positions).

In the proposed system in accordance with an embodiment of the invention, the angular measurements of the radars are used as an aid in the target association process, and are not involved in the accurate measurement process. Therefore, the angular measurements precision requirements can be significantly low, compared to the case where a single radar performs the same task, allowing significant savings in the system cost.

Furthermore, in conventional radars an object's position is obtained by range and direction measurements. Therefore, the position error normal to the line-of-sight to an object depends at least linearly on the range. This is one of the reasons for employing interceptors with on-board seekers; position errors diminish as the interceptor approaches its target. In accordance with an embodiment of the invention, the position error is no longer dependent on range, and in a certain area depends on system geometry. Thus, data with sufficient precision can be obtained to allow interception based on remote sensing of the targets. This, in turn, allows a significant reduction in the interceptor cost.

The target and interceptor data obtained from the radars is processed by guidance algorithms that determine maneuvering commands to the interceptors. These commands are transmitted via an uplink channel and upon execution correct the interceptor trajectory and bring it within a small radius from the target. The interceptor kill mechanism is designed to achieve target warhead destruction.

Two types of interceptors, the maneuvering projectile and the surface-to-air missile, are designed with particular emphasis on low-cost. In addition to the fact that no on-board seeker is required in the interceptors, further reduction in the cost of the projectile is achieved by using the communication receiver also as a roll sensor, thus obviating the need for other on-board sensors.

Another cost saving factor results from similar geometric conditions during the end-game when intercepting ballistic targets. This simplifies the design of the interceptor kill mechanism. In the maneuvering projectile case, the typical interception geometry is head-on, due to its limited effective range. A simple proximity fuse and a standard type of high explosive fragmentation war-head provide high probability of kill.

For the longer range surface-to-air missile a special trajectory shaping is used to force the arrival direction to be parallel to the target. As will be described below, the final approach may be either head-on, tail-chase or tail-on (where the interceptor is positioned ahead of the target with lower speed). A simple proximity fuse and high explosive fragmentation warhead can be designed to guarantee effective target destruction in all the above approaches.

Communication to the interceptors is done, when possible, through a single transmitter. The transmitted data contains guidance commands to all the interceptors in the air. Each interceptor must decipher its own commands. To this end, every interceptor must be identified (i.e. “colored”) such that the identification code is known to both BMC and interceptor. Several coloring methods are possible, including coloring the interceptor in the air immediately after its launch and coloring during the pre-launch process. These methods will be discussed in greater detail below.

By one embodiment, the system is also capable of locating the launching-sites of the ground-to-ground rockets enabling activation of other means against the rocket launchers.

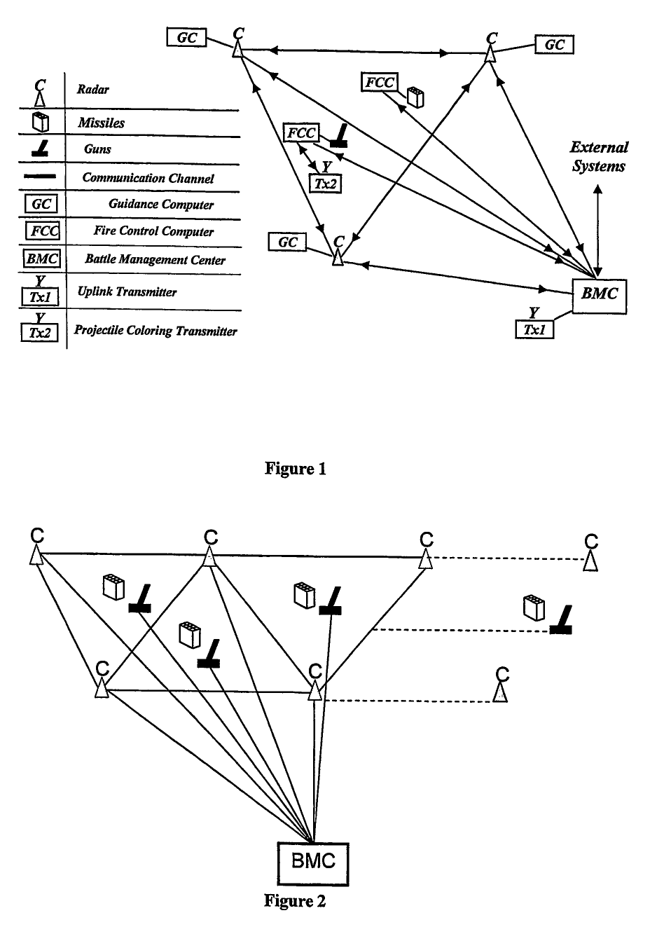

Bearing this in mind, a basic system configuration in accordance with an embodiment of the invention is schematically presented in FIG. 1. It contains three synchronized radars, air defense artillery guns, missile launchers, projectile coloring transmitter, uplink transmitter, Battle Management Center (BMC), communication channels between the fire unit components, and a communication channel between the BMC and external C³ systems. A netting of basic systems is presented in FIG. 2. Such a configuration can be used for regional defense.

Note that the invention is not bound by the system configuration of FIG. 1 or by the netting of a basic system of FIG. 2.

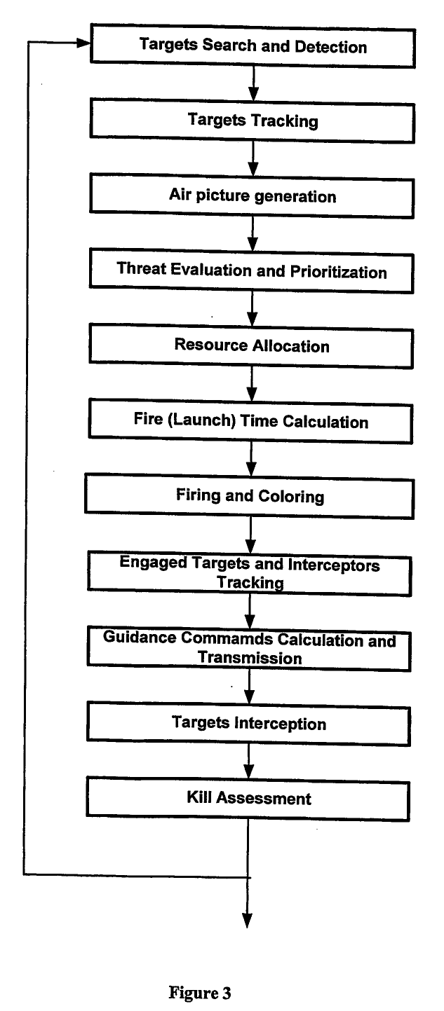

Turning now to FIG. 3, there is shown a flow chart of an engagement cycle in accordance with an embodiment of the invention. The various stages are discussed below.

Turning at first to targets search and detection step, each radar in the network is designed to provide automatic search and detection of threats within predefined azimuth and elevation sectors. The combined sectors of the radars provide total coverage of the desired area. The radars use electronically steered antennae allowing simultaneous search and engagement of multiple targets.

Moving now to the Targets and Interceptors Tracking, each target is tracked by at least three radars (radars triad). Each radar provides rough azimuth and elevation measurements of the threat, and a very accurate range measurement. The three accurate range measurements of the target measured by a radars triad are used to calculate the target position via range triangulation. To enable the triangulation process the radars are synchronized by atomic clocks. Each radar in the triad performs the range triangulation using the range measurements of the adjacent radars received via the communication channels. Following this approach each radar in the triad generates its own track files. The rough angular measurement of each radar in the network assists to associate its range measurement to the target.

The radar system also tracks interceptors that are on their way to intercept targets, using the same method to determine their position.

Moving now to the Air Picture Generation step, the track files of all the radars in the network are transmitted via the communication channels to the Battle Management Center (BMC). These track files together with available target data from external systems are used to generate the air picture. The air picture includes the predicted trajectories of targets that are identified as threats. The air picture also includes the trajectories of the interceptors supplied by the relevant guidance computers.

Moving now to the Threat Evaluation and Prioritization step, the role of this function is to provide the data required to allocate the interceptors to the targets and to determine the fire (launch) time.

This function calculates the potential damage associated with each threat and determines the interceptors which are candidates for a specific target interception. The targets potential damage is used for prioritization. Threats prioritization data together with candidate interceptors' data and engaged threats trajectories are used to calculate the fire (launch) time.

Moving now to the Resource Allocation step, the resource allocation process is performed in the BMC and includes:
Determination of the interceptor type (projectile or missile) required for a specific interception.
Allocation of selected type interceptors.
Allocation of radars to track the threats and the interceptors.
Allocation of command channel for interceptor communication (if more than one uplink transmitter is used).
Selection of master guidance computer (every radar in a triad is equipped with a guidance computer and only one is selected as a source for the guidance commands in a specific interception).
Allocation of coloring data to the interceptors.
Allocation of the Fire Control Computers (FCC's) associated with the selected interceptors.
Fire (Launch) Time Calculation

The fire (launch) time calculation is based on the following data:
Candidate interceptors' data.
Engaged threats trajectories.
Threats prioritization.

This calculation is performed in the BMC.

Moving now to the Firing and Coloring step, to the After the calculation of the fire (launch) time the BMC transmits a fire (launch) command to the allocated FCC. The command includes the specific fire (launch) time for a selected interceptor.

The coloring of the missile interceptor is performed prior to launch via pre-launch communication channel. For the projectile interceptor, in order to reduce cost and complexity, the coloring may be performed in the air immediately after the projectile is fired, using a dedicated low power transmitter located near the gun. In the coloring process the projectile receives its identification code via its communication channel. This code enables the projectile to receive and identify its own guidance commands. Other coloring methods are possible.

Moving on to the Engaged Targets and Interceptors Tracking step, the tracking of the engaged targets and interceptors is performed, as explained before, via range triangulation. The revisit rate of the radars is variable and is increased during the end-game. The estimated position of the engaged targets and interceptors in the interception zone has a very small standard deviation error.

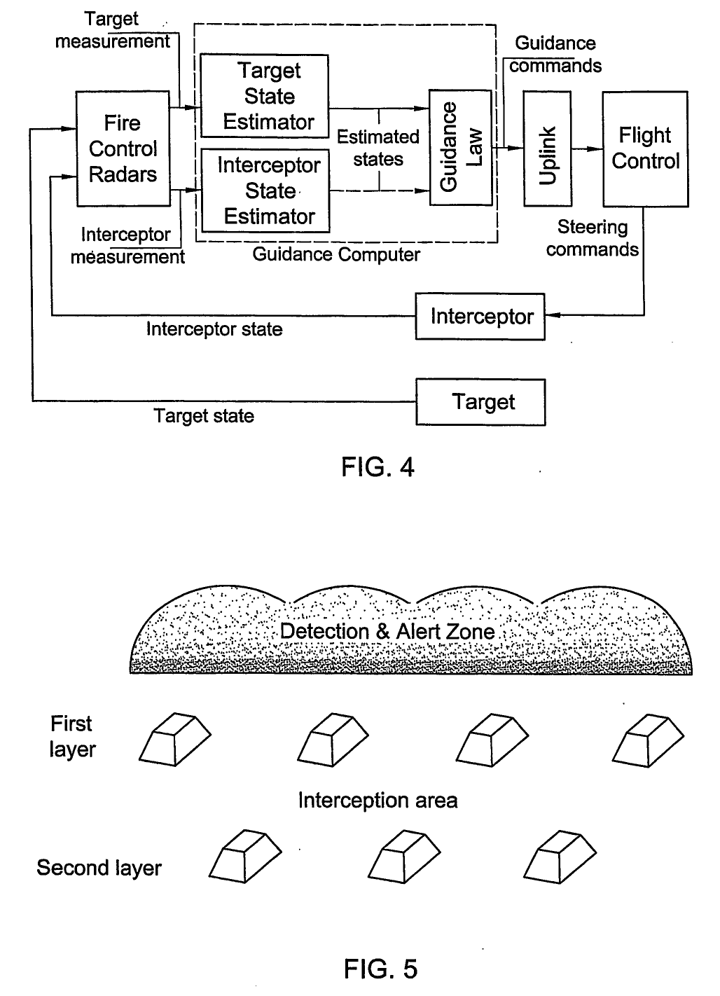

Moving on to the Guidance Commands Calculation and Transmission step, a schematic description of the guidance loop is presented in FIG. 4. The radars' measurements associated with the engaged target and its interceptor are used by the Target State Estimator (TSE) and the Interceptor State Estimator (ISE) to estimate the target state and the interceptor state, respectively. The guidance law uses the estimated states to calculate the guidance commands to the interceptor. Since every radar unit can be associated with more than one triad (see FIG. 2) the guidance computer in each radar may calculate commands for different interceptors in different triads simultaneously. The guidance commands are transmitted to the interceptors via the uplink communication channel. These commands are the input to the interceptor flight control system which generates the steering commands and activates the steering system. The resulted position of the interceptor and the current position of the target are continuously measured by the radar triad. The measurement rate is relatively low during the midcourse and is increased during the end-game.

Moving on to the Targets Interception step, the guidance during the end-game is designed to bring the interceptor within a small miss distance from the target, that will be of the order of the measurement error. The proximity fuse of the interceptor identifies the target leading edge and activates the warhead. The interceptor warhead is designed to achieve a target warhead kill assuming that the target type is known. To increase the probability of successful interception, more than one interceptor can be launched against a target.

Moving on to the Kill Assessment step, the role of this function is to assess the target kill and to decide to re-engage the target if necessary. The kill assessment is based on the radars' measurements of the target and the interceptor after interception to detect the hard kill using the fact that a successful kill creates debris.

Note that the invention is not bound by the engagement cycle discussed with reference to FIG. 3 or by the guidance loop described with reference to FIG. 4.

There follows a description in more details of one embodiment of a main air-defense system elements: the radar system, the maneuvering projectile and the interceptor missile.

Turning at first to the radar system, it provide detection and alert of incoming threats to a wide defended area and accurate tracking of those threats and own interceptors at high update rate for successful engagement.

A possible approach when multi-threat tracking is required is to implement a static electronically scanned radar system that can track simultaneously many targets at the required update rate without the limitations of the scan time of a rotating radar (see Skolnik and Barton Radar books[3]).

Any single radar will provide decreasing Cartesian position accuracy over range. Therefore in order to provide detection and required accurate tracking over wide defended area huge impractical radar is required. Such radar, even if implemented, may be limited due to terrain limitations over a large defended area.

The suggested solution in accordance with this embodiment includes two radar layers network (see FIG. 5):
1. The first radar's layer provides the required detection and alert ranges with relative small ERP (effective radiated power) radars. This layer provides medium tracking accuracy of multiple incoming threats.
2. The second radar's layer lies “behind” the first layer. The area created between the two layers is defined as the interception zone. The combined operation of the two layers, as described herein, provides accurate tracking in the interception zone.

Each radar in the first layer is designed to provide automatic detection of threats in a predefined azimuth and elevation sector. After detection the radars track each threat. Each radar performs the tracking in the conventional way (see Barton) i.e. azimuth, elevation and range measurements and filtering.

When the threat approaches the interception zone the second layer of radars starts functioning.

The second radar layer is deployed in such a way that each relevant threat will be detected and tracked during the end-game process by at least three radars. The interceptors launched against the incoming threats are tracked in a similar way.

The specified radar's layers are provided by way of example only, and are by no means limiting. Thus, in accordance with another embodiment, the detection and alert functionality of the first layer can be assigned to the second layer (or in accordance with another embodiment to a separate system). By still another non-limiting example the deployment of two layers may be modified to employ e.g. radars of different sizes in each layer which operate in different ranges and altitudes.

Each radar is designed to provide medium accuracy of azimuth and elevation measurement of the threat during tracking, but a very accurate threat range measurement. The accurate range measurements of the threat as measured by the three relevant radars in a triad are used to accurately calculate the threat position by range triangulation (similar to the process performed by GPS receivers, with the difference that the time is known and the range is measured by a radar).

Triangulation is a well-known process used in ESM and Comint systems for accurate position finding of emitters. In the GPS it is used for accurate position estimate of the GPS receiver where the GPS emitter's position is known. By this embodiment, the range triangulation process is taken one stage further since there are no receivers on the flying objects and the measurements are to be accomplished on the ground, the radar is used for transmission, reception and range extraction.

To enable the range triangulation process, two aiding sub systems are included at each radar: a very accurate time measuring device (such as atomic clock) and a communication system to get the range information of the adjacent radars in a triad.

Since the range triangulation process provides accurate threat position by range measurements only, the radars are inexpensive small aperture radars with non accurate angle measurement.

The accurate range measurement during tracking is achieved by wideband transmit pulse encoding (such as linear FM) and pulse compression techniques during receive.

The range triangulation process provides a great advantage over accurate radars in price (as mentioned earlier) and in accuracy over range. The later is due to the fact that the cross range accuracy in a single radar measurement deteriorates as a function of range and Signal to Noise Ratio (SNR) while range triangulation accuracy is not directly range dependent and is influenced by the relative geometry and SNR.

The radars are designed to support simultaneous performance of the following functions: threat detection, threat tracking, high update track of engaged threats and high update rate of own projectiles and missiles. To simultaneously support these functions each radar is electronically scanned radar such as Phased array radar, which allows fast redirection of the radar beams by electronic measures in the assigned azimuth and elevation sectors of the radar.

By one embodiment, each radar in the network is built of independent radar faces. Each face covers a sector of up to 120 degrees. The number of faces of each radar is designed according to its location in the network and the required coverage. Normally the number of faces for each radar in the first layer is 3-4 faces while the number of faces for each radar in the second layer is only two. This setup will provide 360 degrees coverage to the first layer and al least 180 degrees to the second layer. The coverage overlapping between the radars will be set according to the number of faces and required coverage.

Note that the invention is not bound by the specified radar system and accordingly other variants are applicable, all as required and appropriate.

For instance, an optional enhancement to the system which takes advantage of the known bistatic effect is also possible. In this case, each time a radar transmits all the radars in its vicinity receive its returns. This allows significant increase of the probability of detection due to the increased number of detections and the increased bistatic RCS.

In such a case the radar implements a multibeam on receive to allow efficient bistatic operation.

Having described a radar system in accordance with an embodiment of the invention, there follows a description of a Maneuvering Projectile in accordance with the invention.

Thus, the short range interceptor is a guided projectile that is launched at the target from a standard anti-aircraft artillery gun. Typically, such a gun is equipped with electric or hydraulic motors that can aim its muzzle in both azimuth and elevation direction. Based on the data received from the Battle Management Center, the gun muzzle is aimed in the appropriate direction and fires a projectile at a specified time to achieve interception at the desired range.

After firing, the radar system tracks the projectile along its ballistic trajectory. Based on the current radar measurements, a correction to the projectile trajectory is calculated. This correction is needed in order to bring the projectile to within the effective warhead distance from the target so that target warhead destruction can be obtained. The calculations are carried out in a dedicated computer in every radar unit (the Guidance Computer) that prepares the guidance maneuvering commands.

The projectile is spin stabilized. It is launched towards the predicted intercept point that is calculated by the FCC. As the interceptor approaches its target, measurement data from the tracking radar are used to calculate the interceptor guidance commands that correct miss distance caused by prediction errors and system disturbances. The projectile receives the commands via an uplink communication channel. The receiver is also used as a roll sensor, providing the projectile with the necessary reference for the resolution of the maneuvering commands. The commands are executed by a propulsive steering mechanism. The projectile is also equipped with a fragmentation warhead and a proximity fuse. When the projectile reaches short distance from the target, the fuse detonates the war-head causing the destruction of the target. Assuming knowledge of the target type, the detonation delay can be adapted to achieve high probability of target warhead kill. The projectile electrical unit consists of a power source, and a computer that manages the functioning of the different elements of the projectile along its flight.

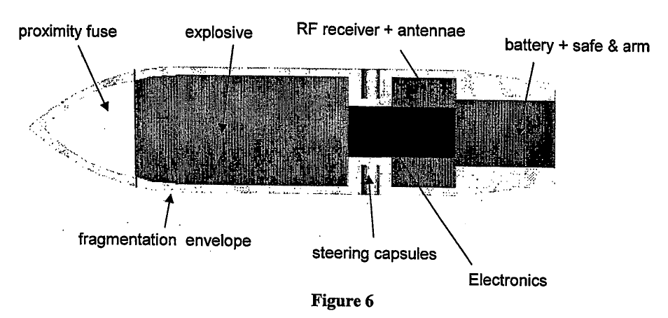

An example of a schematic description of a possible projectile layout is given in FIG. 6. Another option is to reduce the spin rate by using a sabot and to stabilize the projectile with aerodynamic fins. This approach simplifies the design of the steering system. Note that the invention is not bound by the specific layout illustrated in FIG. 6.

Turning now to Projectile Coloring, the uplink data string consists of a series of guidance commands addressed to the projectiles that are in the air. A projectile is identified by a unique identification code. Different methods can be used to install the identification code in the projectile. The description below refers to non-limiting examples of installing identification code in the projectile.

One option is to transmit the code to the projectile by a dedicated low power transmitter located close to the gun. The projectile receives the code after power is built up immediately after exiting the gun muzzle. After receiving the coloring code, the projectile communication algorithm switches to a data reception mode, and is not affected by other coloring messages that may be transmitted to an adjacent projectile.

Other options, such as pre-launch coloring during the gun loading, can be also implemented.

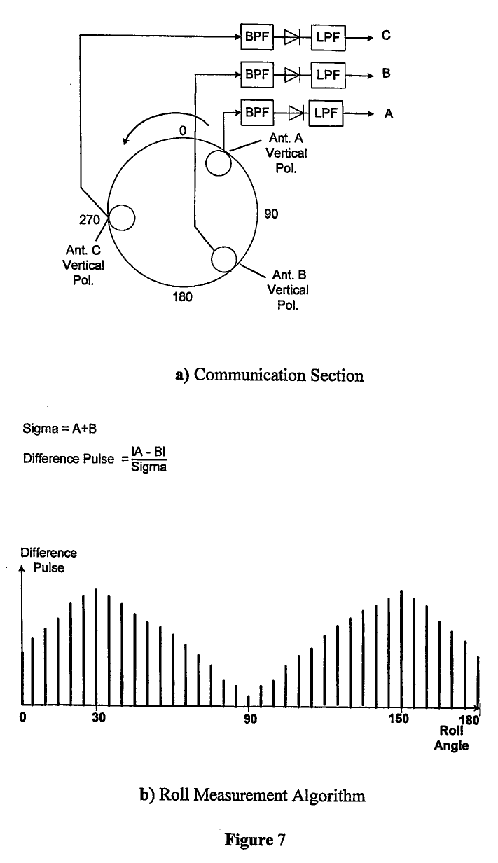

Having described various examples of projectile coloring, there follows a description of Roll Angle Measurement, in accordance with an embodiment of the invention. Thus, the communication channel is equipped with several antennae that are immersed in the projectile skin, positioned around its perimeter. An example of a three antennae solution is given in FIG. 7a. The antennae have identical reception patterns. The magnitude of the received signal is related to the direction of the uplink transmission relative to the projectile. An example of a simple algorithm that determines this direction from the signals of one pair of antennae is described in FIG. 7b. The relative magnitude of the difference between two antennae is examined along a full rotation of the projectile. Equal magnitude indicates that the transmitter up-link direction forms equal angles to the receiving antennae. This situation results in minimum magnitude of the signal difference, as shown in the figure. With this algorithm there is a 180° ambiguity in the direction between the case where the transmission direction is towards the near side of the two antennae and the case where it is on the far side. This ambiguity is resolved by examining the magnitude of the received signal which is significantly weaker in the latter case due to masking by the projectile body.

In the proposed configuration of three antennae, three measurements of the projectile roll angle are obtained during one rotation cycle. These measurements can be processed together to improve the precision of the computed roll angle relative to the transmitter direction. In addition, by measuring the time between two consecutive passes of this direction, the spin period can be also determined. Note that the invention is not bound by the specific examples illustrated in FIGS. 6 and 7.

Moving on to Propulsive steering, the projectile maneuvering is achieved by an active propulsive steering system. One possible way to realize the steering mechanism is to use pulses of thrust, obtained by miniature solid rocket motors located on the projectile perimeter next to its center of gravity. These motors generate thrust normal to the projectile axis of symmetry, pushing the projectile in the lateral direction.

An alternative realization of the propulsive steering unit is by a gas generator, with a side nozzle that releases the jet in the lateral direction. The gas flow through the nozzle is controlled by a valve. The gas generator may use cold gas stored in a high pressure tank. Alternatively, a hot gas can be produced by a solid rocket propellant burning in a closed combustion chamber. The regulating valves must be designed to withstand the high temperature environment. Excess gas must be depleted when no maneuver is required to avoid exceeding the pressure limits. Note that the invention is not bound by the propulsion steering systems, discussed above, for instance aerodynamic steering is applicable, e.g. by aerodynamic fins.

Moving on to the guidance of the projectile, based on the relative target and interceptor position and velocity, guidance commands are calculated in the guidance computers on the ground. The direction of the required maneuver relative to the line of sight from the transmitter to the projectile is calculated and transmitted to the projectile.

The projectile computer activates the propulsive mechanism to generate thrust pulses in the required direction. If the steering mechanism is based on the miniature thrusters, the computer calculates the activation times of available thrusters such that a series of pulses will produce the required maneuver. If the steering mechanism is based on a gas generator with a single nozzle, the algorithm computes the opening and closing times of the nozzle valve. In both cases, the calculation uses the roll and the roll period measurements to determine the steering commands and timings.

Note that the invention is not bound by the guidance mechanism, discussed above.

By one embodiment, the projectile is equipped with a conventional axi-symmetric fragmentation warhead, being an example of the Kill Mechanism. When it bursts in the vicinity of the target, a large number of small high velocity fragments are ejected in a spherical-like spray pattern. Some of them will strike the target and inflict damage. In order to hit and destroy the target warhead, a proximity fuse is used to identify the optimal warhead detonation instant. The fuse identifies the target front edge and generates the detonation signal at a delay that depends on the particular scenario. This delay can be calculated during the interception in the guidance computer and is transmitted to the projectile together with the guidance commands. Note that the invention is not bound by the guidance mechanism, discussed above.

For the defense of larger areas, interception range and altitude must be significantly higher than those obtained by the projectile. Accordingly, by another embodiment of the invention, an interceptor missile provides the required performance for such tasks. The missile is integrated in the same radar network and battle management system. Similarly to the projectile, the missile has no seeker and receives the guidance commands from the ground. It is vertically launched from a canister, and approaches the target in a trajectory dictated by the guidance algorithm. In the case of long range interception scenario, trajectory shaping is used to preserve the missile energy. Trajectory shaping is also used to control the end-game geometry to enhance the effectiveness of the missile kill mechanism.

By one embodiment, the missile is equipped with sufficiently large solid rocket motors that provide enough energy to bring the missile to the required interception ranges. It is stored in a closed canister that is also used as a launcher. The missile can be launched vertically and after gaining sufficient speed performs aerodynamic turn that brings it to an approach trajectory dictated by energetic and end-game considerations. The missile receives the guidance commands from the BMC. In order to execute the commands the missile must measure its attitude relative to the reference coordinates. This can be accomplished by the same method proposed for the projectile interceptor or by a conventional inertial measurement unit. The missile maneuvers until it reaches a small distance from the target. At this stage the proximity fuse identifies the target and detonates the missile fragmentation warhead.

Turning now to the steering system, the missile steering is aerodynamic (using aerodynamic fins to control the angle of attack). A possible low cost implementation is a rolling airframe configuration. This configuration is similar to the RAM [4] where control is achieved by a single pair of aerodynamic fins. The missile steering fins are controlled by actuators that may be either electrical or pneumatic.

Using trajectory shaping, the interceptor missile is guided to interception in a parallel flight pattern, i.e., such that the interceptor and the target velocity vectors are parallel. According to the initial geometry, this requirement can be realized either by flying in an opposite direction to the target (head-on interception) or by flying in the same direction. In the latter case, depending on the interceptor and target speeds, the interceptor missile will be guided to fly either behind the target (tail-chase interception) or ahead of it (tail-on interception). The tail-on approach is based on a technique disclosed in U.S. Pat. No. 6,209,820 issued Apr. 3, 2001, where it was indicated that in the case of a predictable target, such as a non-maneuvering ballistic missile, interception can be made simpler when the closing velocity is made smaller. This can be achieved by guiding the interceptor to fly along the target trajectory, and when possible, positioning the interceptor ahead of the target. Note that trajectory shaping in the manner specified is only an example. By another embodiment, the design of the kill mechanism and the trajectory shaping may be combined such that the kill mechanism can compensate for the trajectory shaping considerations and vise versa. For instance, interception can be accomplished not necessarily by using parallel trajectories, however, to this end, appropriate (known per se) kill mechanism is utilized.

Turning now to a proximity fuse, the constraint on the interceptor flight direction when it approaches the target is introduced in order to increase the probability of the target warhead destruction. Under normal circumstances, the type of target is known in advance. If more than one type of threat is present in the arena, target identification can be achieved by evaluation of the returning radar signals and the kinematic data. It can be therefore assumed that the location of the target warhead relative to the target airframe is known. However, precise identification by the remote radars of this location cannot be guaranteed. In the suggested end-game geometry, the target front or rear end can be easily identified by a conventional electro-optic proximity fuse. This fuse will consist of forward looking and backward looking axi-symmetric beams that will detect the target edge in either direction.

The kill mechanism is a conventional axi-symmetric fragmentation warhead, specifically designed such that sufficient number of energetic fragments will penetrate the target skin and effectively destroy its warhead. The missile warhead is detonated upon receiving the detonation signal from the fuse. The time delay between the target edge detection by the fuse and the warhead detonation is calculated in the missile computer, based on target and relative kinematics data provided by the BMC.

The uplink channel comprises of one or several communication transmitters. The number of the transmitters is determined by geometrical considerations; It is required that the interceptor will have unobstructed line of sight to the transmitter along its entire trajectory. Furthermore, since in the case of the projectile interceptor, the transmission is used to determine the roll direction, the location of the transmitter must be such that it will be viewed by the projectile from the side.

The communication units transmit the guidance data to each interceptor as calculated by the guidance computer. The data for each interceptor is preceded by its coloring identification. Note that the invention is not bound by the missile interceptor and/or components thereof, discussed above.

There follows a description of a typical, yet not exclusive, example of the proposed air defense system. The system main parameters are given first, and then the operation sequence in a typical scenario is described. Note that the invention is not bound by the given system parameters or by the operation sequence in a typical scenario.

The radar unit is a Phased Array mono-pulse radar with range resolution of 10 cm and angular resolution of 6°. The triad units are positioned on hill tops creating almost equi-lateral triangle. The distance between two radars is about 20 Km.

The interception zone lies above the radars triangle since this is the area where range triangulation error is minimal. Inside the interception zone, the triangulation error is 0.3 m′ (1σ). The radars beams can be directed electronically in a sector of ±60° with respect to the normal to the antenna plane in both azimuth and elevation. The radars antennae for the end-game measurements are, therefore, positioned facing the center of the triangle, and inclined 30° above the horizon. This way, the triad covers the entire area above the triangle. Additional radar faces are allocated in the first layer for target detection. Furthermore, each radar unit can measure objects outside the triangle, using its own directional measurements, providing detection capability of lower precision that is sufficient for alarming and preparing the system for treating the approaching threat.

The radar is designed to detect low RCS targets. It can detect large rockets at a range of 30 Km and a small rocket at a range of 10 Km. The range is measured from the radars front layer.

The short range interceptor is a maneuvering 76 mm projectile launched from an OTO-Melara naval gun model 62, adapted for the ground based air defense mission. The gun firing rate is 120 rds/min and can therefore be used against a barrage attack of artillery rockets.

The projectile weighs 6.5 Kg, is fired with muzzle speed of about 1000 m/sec and reaches effective intercept range of 5 Km. The on-board steering mechanism is designed to correct 10 m′ deviation during the last second of the flight before hitting the target.

The interceptor missile is, e.g. an extended range version of the Rafael's Barak air defense missile. It is adapted to the mission of high altitude interception by introducing an improved larger rocket motor, improved aerodynamics and replacement of the original RF proximity fuse by an electro-optic proximity fuse, as explained above. The missile is capable of intercepting ballistic targets at ranges up to 30 Km from the launch site.

The present invention has been described with a certain degree of particularity, but those versed in the art will readily appreciate that various alterations and modifications may be carried out without departing from the scope of the following claims:

1. A system comprising:
a synchronized network of at least three search and track radars and associated processing means and communication channel; the radars are configured to detect and track at least one target; in response to detected at least one target, at least one interceptor is launched towards said at least one target; the radars are configured to measure and track the at least one target and the at least one interceptor; the target and interceptor ranges are accurately measured by said at least three radars in the synchronized network, giving rise to synchronized accurate range measurements; the synchronized measurements are combined by range triangulation to provide accurate target and interceptor position measurements irrespective of the angular measurement accuracy of each radar; the processing means are configured to utilize the measurements to calculate interceptor maneuvers required to overcome errors and bring the interceptor close to a target; the maneuver commands are transmitted to the interceptor using the communication channel; the interceptor is equipped with kill mechanism designed to destroy a target warhead when said interceptor approaches the target.

2. The system according to claim 1, wherein said range triangulation provides accurate target and interceptor position measurements which do not deteriorate linearly with range and said interceptor does not employ on-board seeker.

3. A rolling interceptor being devoid of inertial roll sensor and equipped with circumferential communication antennae that are configured to receive maneuvering commands from a command transmitter; the interceptor is configured to use said antennae to provide a reference for resolution of the maneuvering commands.
